(19) United States
(12) Patent Application Publication
(10) Pub. No.: US 2003/0130014 A1
(43) Pub. Date: Jul. 10, 2003

(54) Reduced complexity user interface

(76) Inventor: David B. Rucinski, Red Bank, NJ (US)

Correspondence Address: MOSER, PATTERSON & SHERIDAN L.L.P., 595 SHREWSBURY AVE, FIRST FLOOR, SHREWSBURY, NJ, 07702, US

(21) Appl. No.: 10/224,214

(22) Filed: Aug. 20, 2002

Related U.S. Application Data
(60) Provisional application No. 60/346,479, filed on Jan. 7, 2002.

(51) Int. Cl. H04M 1/00; H04B 1/38

(52) U.S. Cl. 455/566; 455/550; 455/556

(57) ABSTRACT

A user interface for use in a reduced complexity computing device adapted for use in an instant messaging service application.

### CROSS-REFERENCE TO RELATED APPLICATIONS

This application claims benefit of U.S. provisional patent application Ser. No. 60/346,479, filed Jan. 7, 2002, which is herein incorporated by reference in its entirety.

This patent application is related to simultaneously filed U.S. patent application No. ______ (Attorney Docket ELIT/003) entitled MESSAGING SYSTEM, APPARATUS AND METHODS, which is incorporated herein by reference in its entirety.

### TECHNICAL FIELD

The invention relates to the field of communication systems and, more specifically, to a user interface adapted for use in a reduced complexity wireless device.

### BACKGROUND OF THE INVENTION

Wireless communications devices such as cellular telephones and the like are widely used and are provided with a telephone-like user interface. While this telephone-like user interface is well-suited for executing standard telecommunications functions, the user interface is somewhat cumbersome for non-telecommunications functions such as electronic mail, text messaging and the like. Moreover, as wireless devices having non-telephone form factors are deployed, the limitations of a telephone-centric user interface will become more prominent.

### SUMMARY OF THE INVENTION

These and other deficiencies of the prior art are addressed by the present invention. Specifically, a user interface according to one embodiment of the invention comprises a plurality of display regions for identifying respective functions of corresponding input devices, the functions associated with an application having a plurality of contexts and changing as appropriate with changes in the application context.

### BRIEF DESCRIPTION OF THE DRAWINGS

The teachings of the present invention can be readily understood by considering the following detailed description in conjunction with the accompanying drawings, in which:

FIG. 1 depicts a high-level block diagram of a system according to an embodiment of the invention;

FIG. 2 depicts a high-level block diagram of a controller suitable for use in the system of FIG. 1;

FIG. 3 depicts the faceplate of an exemplary wireless device suitable for use in the communications system of FIG. 1;

FIG. 4 depicts a graphical representation of a display sequence associated with a IM session; and

FIG. 5 depicts a graphical representation of a display sequence associated with a menu selection.

To facilitate understanding, identical reference numerals have been used, where possible, to designate identical elements that are common to the figures.

### DETAILED DESCRIPTION OF THE INVENTION

The subject invention will be primarily described within the context of a system in which a base station working in conjunction with a computer accesses an instant messaging service via the Internet. The base station communicates in a wireless manner to one or more wireless devices having respective users to enable the communication of instant messages between each of the one or more wireless devices and the instant messaging service. The base station cooperates with a computing device that is communicating with the Internet or other network. Text messages may also be passed via the Internet, where the communicating and receiving devices cooperate with different base stations. Text messages are communicated from a wireless device to a central messaging server via the Internet and propagated to a recipient (e.g., another instant messenger subscriber) via the Internet. The form factor of the wireless device, as well as the user interface by which the wireless device is operated, are not telephone-centric; rather, the form factor and user interface are adapted to facilitate rapid text messaging operations within a plurality of instant messenger sessions. Other applications beyond the described instant messenger application may be used, such as voice applications and collaborative document preparation applications.

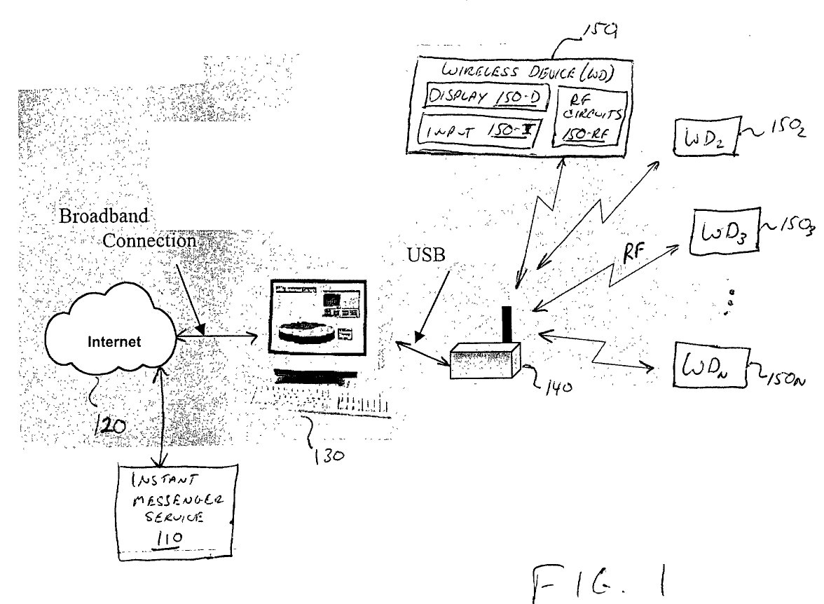

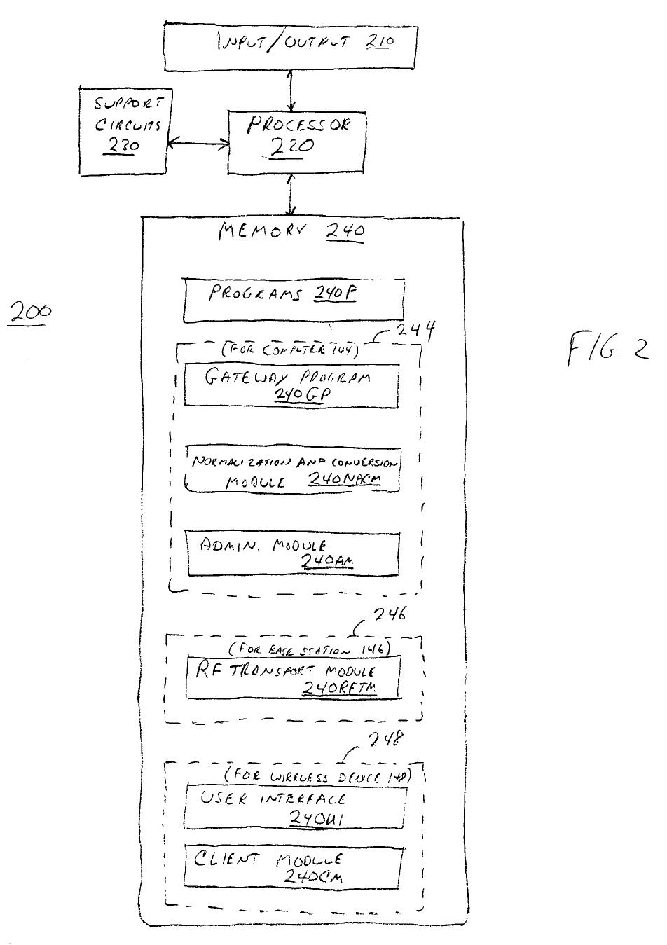

FIG. 1 depicts a high-level block diagram of a communications system useful in understanding the present invention. The communications system 100 of FIG. 1 comprises an instant messenger service (IMS) 110 that communicates with IMS subscribers via the Internet 120. Each of a plurality of subscribers is associated with a respective wireless device 150₁ through 150_{N} (collectively wireless devices 150). Each of the wireless devices 150 communicates with a base station 140 via a radio frequency (RF) link. The base station 140 communicates with a computing device 130, such as a personal computer (PC), Macintosh or Linux system via, illustratively, a universal serial bus (USB) or other communications link. The computer device may also comprise a personal digital assistant (PDA) or other device. The computing device 130 communicates with the Internet 120 via a broadband or narrow band (e.g., dial-up) connection. The system 100 of FIG. 1 is described in more detail in U.S. patent application No. ______ (Attorney Docket ELIT/003) entitled MESSAGING SYSTEM, APPARATUS AND METHODS, which is incorporated herein by reference in its entirety.

The computing device 130 operates a client that translates messages adapted for use by the instant messenger service 110 to a reduced complexity protocol adapted for use by the wireless devices 150. The translation function is used to adapt messages transmitted by or received by the wireless devices 150. It is noted that the protocol translation function performed by the client is adapted to any of the instant messenger service protocols such that a wireless device user may perform an instant messaging function with AOL Instant Messenger, MSN Messenger, Yahoo! Messenger or any other service.

The base station 140 may be an integral part of the computer 130 or may be a separate device connected to the computer. For example, the base station may comprise a card or other device inserted into a slot and sharing or communicating with computing resources via the computer system bus. Alternatively, the base station may comprise a separate device connected to the computer by a universal serial bus (USB) or other serial interface, a parallel interface or a network connection (e.g., Bluetooth or Ethernet). The terms computer, base station and wireless device should be broadly construed herein to mean, respectively, computing function, base station function and wireless device function. These functions may be combined as described herein.

The radio frequency (RF) protocol utilized in the system 100 of FIG. 1 is designed to permit wireless device to base station communications for multiple wireless devices or handsets. The RF protocol uses, preferably, time-domain signaling with the base station acting as a master to synchronize responses from individual wireless devices. Frequency domain signaling may also be used, though at present time-domain signaling is less expensive. Various wireless technologies such as wideband, ODFM, Bluetooth, 802.11 and the like may also be employed within the context of the present invention. In addition, custom RF protocols and techniques may be used, such as frequency hopping and/or spread spectrum.

Each of a plurality of wireless devices 150₁ through 150_{N} (collectively wireless devices 150) are shown in FIG. 1 may be considered to be part of a group of wireless devices 150. The inventors envision that in one embodiment, each group represents a household such that an existing computer within the household may have attached to it a base station that wirelessly cooperates with at least one wireless device to enable instant messaging capability for each wireless device within the group. In this manner, the wireless devices within the group may communicate with each other and with other subscribers to the instant messaging service as long as such devices are within the range of a base station allowing access.

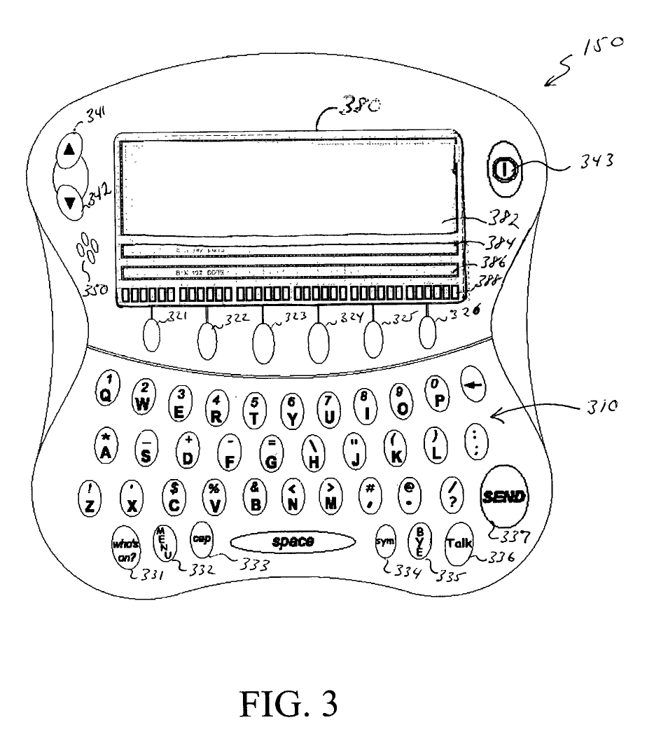

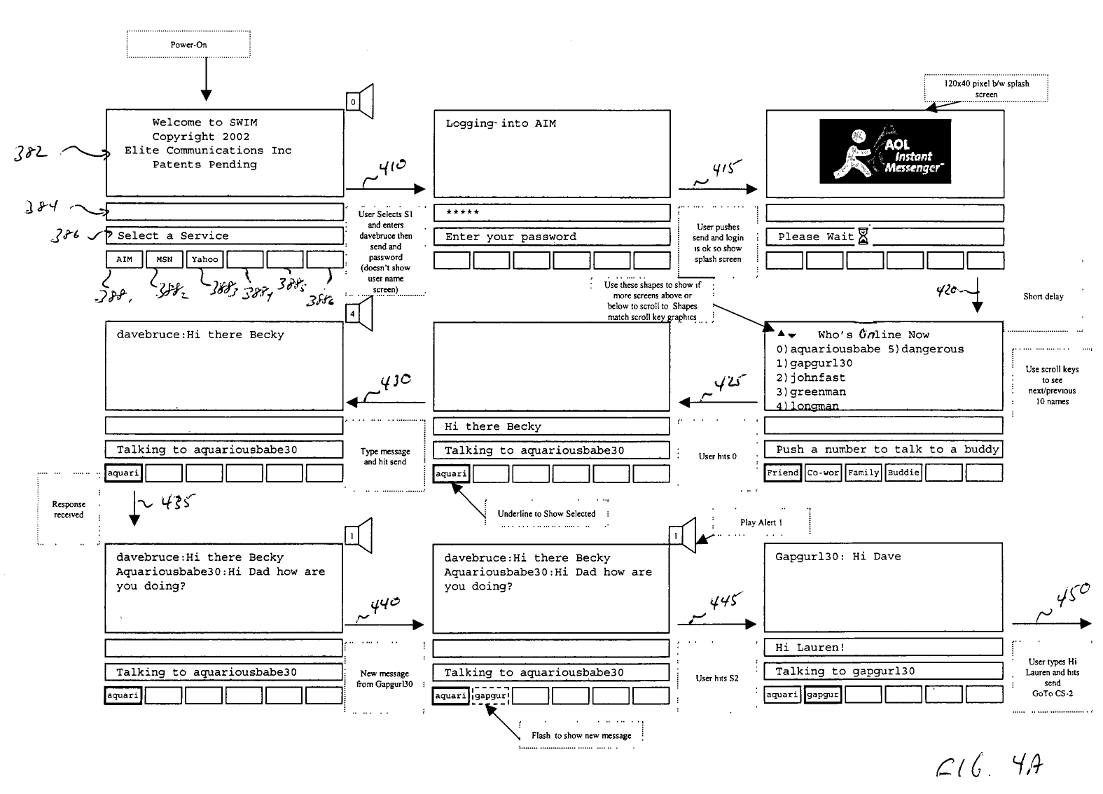

Each of the wireless devices 150 includes an output means 150-D such as a display device (e.g., a liquid crystal display (LCD) or other display device), an input device 150-I such as a keypad or touch screen, and various radio frequency (RF) circuits 150-RF including RF appropriate chip sets, antenna and the like adapted for communication with the base station 140. The input means and display means enable a user to, respectively, input message or command data and display input or received message and command data. The user may enter text into the device by holding the device in two hands and performing “thumb typing;” by placing the device on a table and using a two-finger “poke typing” technique or by holding the device with one hand and “poke typing” with the other hand. Preferably, the wireless device includes an angled keyboard and display surface enabling easy viewing and typing, hand grips on each side of the device for one or two hand comfort when holding the device, and contours underneath the device to improve user grip of the device. A user interface according to the present invention is described in more detail below with respect to FIGS. 3-5.

Optionally, each of the wireless devices includes an alerting means (e.g., sound or light generation means) for alerting a user that a message has been received, that a connection or registration has been made, or other functions have been achieved, such as discussed elsewhere within this application. In one embodiment, alerts are generated using the RTX file format (which is used to specify ring tones in some cellular telephones).

It will be appreciated by those skilled in the art that different physical layers may be utilized to effect communication between the computing device and base stations, and to effect communication between the base stations and respective mobile computing devices. Moreover, the mobile computing devices may comprise devices such as discussed herein, mobile telephones, personal digital systems (PDAs) and the like.

As part of an instant messenger registration process, the user enters information into the wireless device or computing device such that the application software running within the computing device is informed as to the instant messaging service or services to which the user subscribes, the log in and/or password information associated with the user subscription, the “buddy lists” or other groups of instant messaging system subscribers that are to be informed of each other's active presence with the instant messaging service. Multiple buddy lists may be utilized such as friends, co-workers, family members and the like. Additionally, multiple services may be used, such as AOL Instant Messenger, MSN Messenger, Yahoo! Messenger and the like. Instant messaging (IM) sessions operate, from the perspective of the user, in the same manner as if the user was sitting at his computer.

All translations of protocols and the like are handled by software operating within the computing device or, optionally, the base station. Users may log off, chat, hide, set alerts and the like in accordance with the standard functions offered by the various instant messaging services. The wireless device 150 is also responsive to a series of error messages to help guide a user in establishing, conducting and/or terminating an instant messaging session. Additional user help may be provided via the display of the wireless device to set wireless device functions, base station functions and application software functions.

Software executing on the computing device 130 performs protocol and translation functions such that existing instant messaging services may be utilized by operators of the wireless handheld devices. In one embodiment, the wireless handheld devices may be registered for use with a plurality of base stations, such that a coverage area within which the registered wireless handheld device is active can be greatly increased. The process of registration comprises establishing a communication link between a base station and a handheld device. The establishment of such communication may be automatic (e.g., each base station responds to each handheld device within its range) or controlled (a base station selectively responds to devices requiring registration). Security protocols are preferably utilized wherein registration only of a predefined subset of mobile devices is allowed for each base station (i.e., those identified as part of a “family” of devices during an initial programming of the base station).

FIG. 2 depicts a high-level block diagram of a controller suitable for use in the system 100 of FIG. 1. Specifically, the controller 200 of FIG. 2 comprises a processor 220 as well as memory 240 for storing various programs 240P as well as a user interface program 240U1. The processor 220 cooperates with conventional support circuitry 230 such as power supplies, clock circuits, cache memory and the like as well as circuits that assist in executing the software routines stored in the memory 240. As such, it is contemplated that some of the process steps discussed herein as software processes may be implemented within hardware, for example as circuitry that cooperates with the processor 220 to perform various steps.

The controller 200 also contains input/output (I/O) circuitry 210 that forms an interface between the various functional elements communicating with the controller 200. For example, if the controller 200 is used to implement the computer function 144 in the system 100 of FIG. 1, the I/O circuitry 210 is used to facilitate communications between the computer 144 and each of the network interface device 142 and base station 146. If the controller 200 of FIG. 2 is used to implement the base station function 146 in the system 100 of FIG. 1, the I/O circuitry 210 is used to facilitate communication between the base station 146 and each of the computer 144 and any wireless devices 148. In the case of wireless communications, an antenna (not shown) is used to facilitate such communications with the base station.

The architecture of the controller 200 of FIG. 2 may be replicated and used to implement each of the various functions discussed above with respect to the system 100 of FIG. 1; namely, the instant messenger service function 110, the network interface device function 142, the computer function 144, the base station function 146 and the wireless device function 148.

The memory 240 is depicted as optionally including a set of software modules 244 intended for use in the computer 144, a set of software modules 246 intended for use in the base station 146 and a set of software modules 248 intended for use in the wireless device 148. It is noted that the particular software modules actually stored in memory are adapted in response to the particular function implemented using a version of the controller 200 of FIG. 2.

The controller 200 when used to implement the computer function 144 includes within memory 240 various programs 244 associated with the computer function. For example, a gateway program 240GP is used to bi-directionally convert the specific protocol messages for each service to a simple or reduced set of commands and data structures. That is, for each instant messaging service, a specific gateway program module adapts service specific protocol data structures into a reduced or simple set of commands and data structures. Similarly, a normalization and conversion module 240NACM converts the different service-specific gateway commands and data structures to a single common set of interface commands and data structures. This common set of interface commands and data structures may be implemented as an intermediate protocol or light protocol. In this manner, the operation of a wireless device 148 is simplified since the wireless device need only process data according to a single language or format. A conversion element of the normalization and conversion module 240NACM formats commands and data structures provided by the normalizing module to and from the lightweight protocol for transport over the RF link between the base station and the wireless device(s).

An administration module 240AM permits users to administer optional preferences. Such preferences may include, for example network interface options, message alert melodies, or parental controls for message types that may be received that may be modified by a user via a command sent to the base station. Some administration options impact the behavior of the normalizing and conversion model. Others control the network interfaces.

The normalizing and conversation module 240NACM operates to convert dissimilar messaging protocols to a common interface and then translates the common interface elements into a lightweight or intermediate protocol.

Although the controller 200 of FIG. 2 is depicted as a general-purpose computer that is programmed to perform various control functions in accordance with the present invention and disclosure herein, the invention can be implemented in hardware as, for example, an application specific integrated circuit (ASIC). As such, the process steps described herein are intended to be broadly interpreted as being equivalently performed by software, hardware or a combination thereof.

In one embodiment of the invention, some or all of the following ten alerts are provided: power on and awake from sleep mode; new message arrived; buddy arrived (played when buddy list entry comes on line); buddy left (played when buddy list entry goes off line); send (played when message is sent with entered key); service disconnected; service connected; out of range (unable to communicate with base station); returned to in-range (communication with base station reestablished); and enter sleep mode (wireless device enters reduced power mode after inactivity for a predetermined period of time, such as ten minutes. During sleep mode or reduced power mode, the wireless device may periodically energize itself and determine if new messages have been received or new alerts have been received.

It will be appreciated by those skilled in the art that while the inventions described herein are described primarily within the context of text or alphanumeric communications, the inventions are also applicable to voice and video communications. That is, rather than establishing text-based communication sessions between users or between a user and another entity (e.g., a remote server), a voice communication or a video communication may also be established. For example, in the case of the mobile handheld device comprising a mobile telephone, a voice or video messaging service may be employed rather than a text messaging service. Similarly, in the case of a messaging service in which a user has requested a particular file, such as a video or audio file, a server storing such video or audio file may be caused to transmit the requested file to the user's (or another user's) computing device, base station or handheld device. It will be appreciated by those skilled in the art that the system architecture described herein has many varied uses, and that such uses are contemplated by the inventors.

The user interface (Ul) disclosed herein advantageously allows a user to juggle multiple conversations or text message sessions (such as interactive text messaging with a plurality of other users). The user interface enables straightforward transitions between different tasks or text sessions by each of the users. In one embodiment each conversation has associated with it a respective button on the user interface.

### EXAMPLE

After user has been authenticated, buddy list information and active buddy states for that user needs to be sent to the wireless device associated with that user. In one embodiment, the messages use the following structure for the data field where the ↑ character represents a value of 0feh and is used to delimit the data fields:

“List Name↑ Buddy 1↑ BIDA/IBuddy 2↑ BIDA/I . . . Buddy↑ N↑BIDA/I”

A buddy identifier (BID) is an identifier that the PC client assigns to that buddy and is an 8-bit integer with a value between 0 and 254. The BID is used in handling subsequent incoming messages and lets the wireless device 148 quickly associate a message with an ongoing session without having to sort through many multi-character names. The wireless device 148 discards any previous association with a buddy name if a BID number is reused by the PC Client in a buddy list message. For example, a buddy list called “Friends” with three names Bill, Joe, and Mike with only Mike being online, would have a data field that looks like this: “Friends↑Bill↑01hIJoet↑02hIMike↑03hA”

A Buddy Event Message (BE) is a message used to notify the wireless device user as buddies go on and off line. A BE can also be used to sound alerts to the wireless device user to indicate a buddy has come or gone. Preferably, only state changes are sent with these messages, and changes are sent for buddies that have been previously sent to the Wireless device in a Buddy list message. The data field format of a BE is: “BIDA/I↑BIDA/I↑. . . ” where BID is the BID that was previously used in a buddy list message and the character A or I indicate if the new state is active or inactive.

An Open Chat Window Message (OCW) is a session message from the wireless device that is interpreted by the PC client as a request to open a IM window for the wireless device to display the IM or chat session in. The Open Chat Window Message has the following format for the data field:

“Name_IM_From↑CHID”

A Close Chat Window Message (OCW) is a session message from the wireless device that is interpreted by the PC client as a request to close an open IM window. The Close Chat Window Message has this format for the data field: “CHID”

A Deny Chat Window Message is a session message from the wireless device that is interpreted by the PC client as a request to deny the PC client the opening of a new window. This is necessary to guard against the event of the wireless device opening the last available IM session window when at the same time as the PC Client tries to open a new IM session window. The data field for this message is the CHID value of the OCW command received that cannot be opened.

Instant Messages (IM) are communicated using the Instant Message type message. Instant Messages have the following data format: “N↑Name_IM_To↑. . . Name_IM_To↑Name_IM_From↑CHIDText of Message” where N is illustratively between 0 and 9 and is the number of Name_IM_To fields to follow. The message is used to open a messaging session in one window to each of the listed names. The CHID identifies which IM session window the message is going to or is from on the wireless device. Once a CHID has been established, it is not necessary for the handheld to resend the to names; the PC client should remember the associated names for this CHID and forward the message to all recipients. For IM sessions that are initiated, the Name_IM_From is the name of the inviter to the IM session. If the total size of the data field is less than, for example, 254 characters, then the IM text may be truncated to meet this limit.

An IM Approval Message (IMA) is an optional administrative message that gives the user the option to accept or reject communication with another user person. The data field for this message has this format: “Name_IM_From↑Session Type” This is contemplated to be an administration option the user makes on the PC Client.

Approve IM (AIM) and Deny IM (DIM) Messages are used to indicate the response that a wireless device user makes to the query from the PC Client. These messages have no data field. The PC Client should never have more than one outstanding IM Approval Message at a time.

FIG. 3 depicts the faceplate of an exemplary wireless device suitable for use in the communications system of FIG. 1. Specifically, FIG. 3 depicts input and display functions associated with an embodiment of the wireless device 150 of the communications system 100 of FIG. 1. The following discussion of the depicted input and display functions will primarily focus on the user interface aspect of the wireless device 150. As such, the methodology used to implement the below-described user interface functions is primarily executed by a controller 200 adapted for use within the wireless device 150, such as described above with respect to FIG. 2 and in U.S. patent application Ser. No. ______ (Attorney Docket ELIT/003) entitled MESSAGING SYSTEM, APPARATUS AND METHODS, which is incorporated herein by reference in its entirety.

The exemplary wireless device 150 of FIG. 3 comprises keypad input means including a plurality of keys 310 arranged in, for example, a “QWERTY” configuration and including alphabetical, numeric, space, capitalization and assorted symbol keys. Most keys perform multiple functions in conjunction with one or both of a “CAP” key 333 and a “SYMBOL” key 334.

The input means also includes a plurality of dedicated function keys, including a key denoted as a “WHO'S ON?” key 331, a “MENU” key 332, a “BYE” key 335, a “TALK” key 336, a “SEND” key 337, and a scroll up key 341 and a scroll down key 342. In addition, a power on/off key 343 is shown. The dedicated function keys are adapted to facilitate rapid user interaction with the instant messaging application to which the wireless device is primarily adapted.

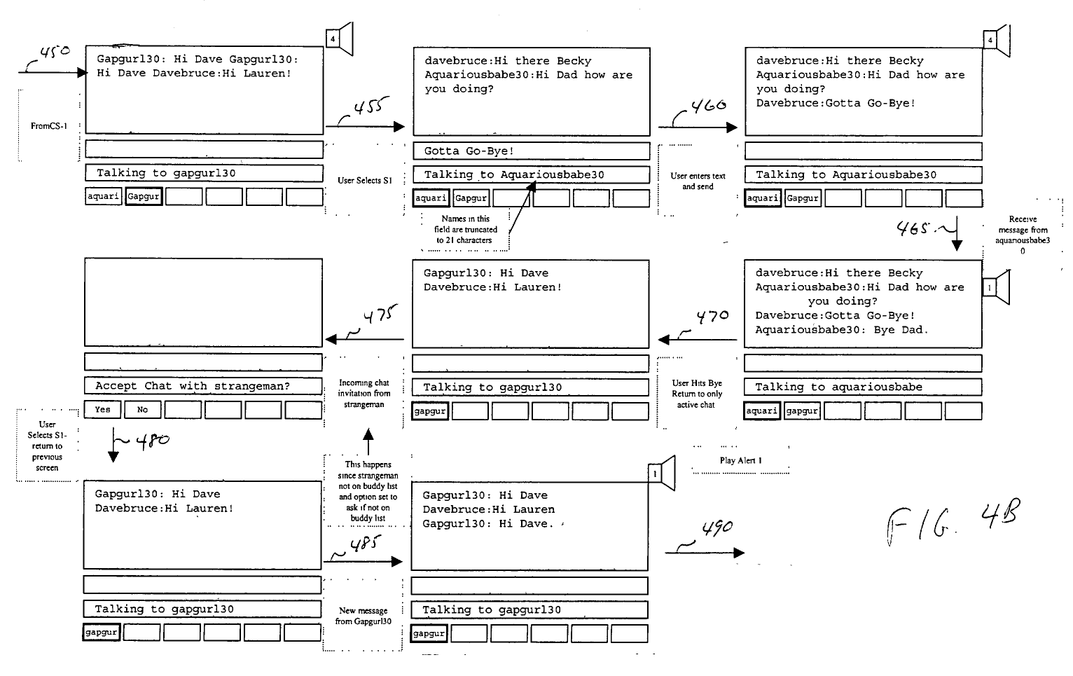

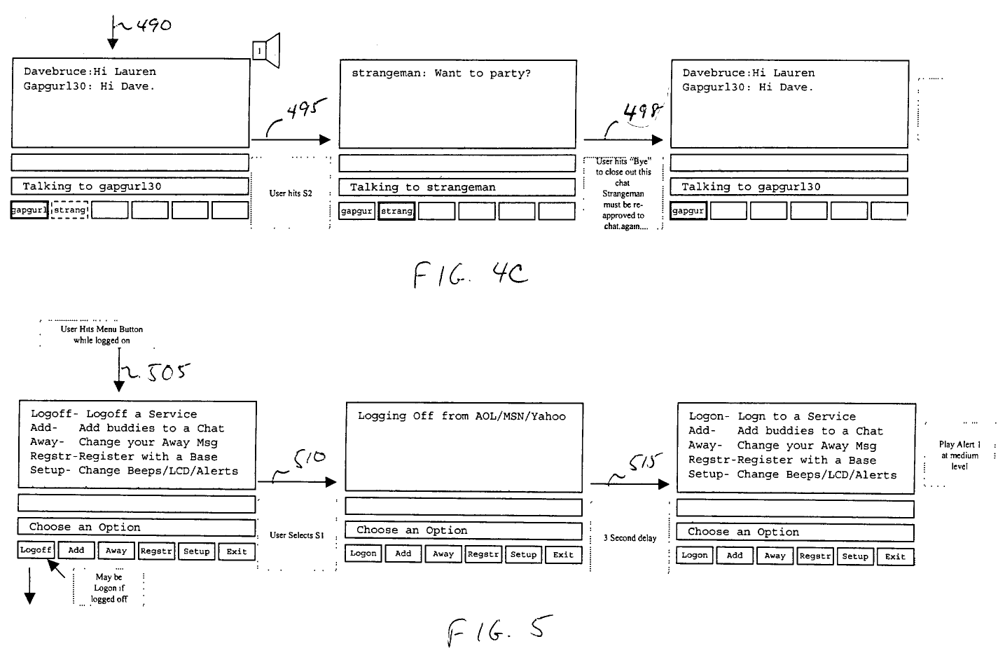

The “WHO'S ON” key 331, when activated, results in the display of a “WHO'S ON” screen on the display device 380. This screen identifies those subscribers that are on line and within, for example, a buddy list or chat group associated with the user. This screen is shown after step 420 in FIG. 4 below. The “MENU” key 332, when activated, results in the display of a “menu” screen on the display device 380. This screen identifies various menu functions that may be selected by the user. This screen is shown after step 505 in FIG. 5 (in the use of a user presently logged on). The “BYE” key 335, when activated, results in the termination of an active IM session. The “TALK” key 336, when activated, results in the display of a “TALK” screen on the display device 380 (i.e., a change in context to the active buddy or IM session). The “SEND” key 337, when activated, results in the transmission of the presently entered text to the presently active IM session participant. The scroll up 341 and scroll down 342 keys, when activated, respectively result in scrolling up or down within the main text area (i.e., the first display region 382) of the display device 380. The power on/off key is used to cycle power in the wireless device.

The instant messenger application to which the wireless device 150 is adapted has several contexts of operation; namely, the “WHO'S ON” context, the “MENU” context and various sub-contexts therein. For example, within the context of an active IM session, a user may jump between various other active IM sessions, establish new IM sessions, terminate existing IM sessions, reject invitations to chat and the like. Similarly, within the menu context, a user may perform various functions such as logging on, logging off, registration and other housekeeping functions and the like. Activation of the “WHO'S ON” and/or “MENU” keys causes the context within which the user operates to change.

The input means also includes a plurality of “soft” keys, denoted as keys 321-326. Each of the soft keys comprises a standard “hard” key that is proximate a display device 380, which display device is used to illustrate the function of the various soft keys. In one embodiment disclosed herein, each key is proximate a six character display field that indicated a respective present or contextual function for the key. In this manner, the various keys may have multiple functions depending upon the present operating context (e.g., IM session management/use, menu functions or other functions). For example, by associating one or more of the on-line subscribers with the soft keys 321-326, subsequent activation of a soft key opens an IM session with the corresponding subscriber.

The exemplary wireless device 150 of FIG. 3 comprises visual and audible output means. Specifically, an audible output means 350 such as a speaker provides an audible indicator to a device user or, in one embodiment of the invention, voice output from a Voice over Internet Protocol (VolP) instant messenger service. The visual output means comprises a display device 380 including active regions and inactive regions. The active regions comprise those regions of the display device 380 including active pixel elements (pixels). The inactive regions comprise those regions of the display device that do not include pixels. By using a display device including active and non-active regions, the cost of the display device is reduced. Moreover, by segmenting the active regions in an intelligent manner using the inactive regions, different regions associated with different functions may be clearly delineated. It is noted that inactive regions may comprise regions that include pixel elements not utilized (e.g., a display device comprising a grid of pixels where some of the pixels are never activated) or not present (e.g., a display device comprising “blank” areas in which no pixels are disposed).

Active regions of the display device include a first region 382, a second region 384, a third region 386 and a plurality of fourth regions 388. In the embodiment of FIG. 3, it is noted that the first region 382 is a relatively large region comprising 55 rows of pixels where each row includes 192 pixels. The second and third regions are depicted as eight row by 192 pixel regions. Each of the fourth plurality of regions 388 comprises six characters, where each character utilizes nine rows of pixels with five pixels in each row. The first display region 382 comprises a 32 by 6 character area supporting text chafting and general messaging functions, the second display region 384 comprises a 32 by 1 character region for displaying sent text, the third display region 386 comprises a 32 by 1 character active pixel region for status/query text messages and the fourth display region 388 supports a plurality (e.g., six) of sub-regions, where each sub-region comprises six characters. Other combinations of regions, rows and/or pixels per row may be readily used by those skilled in the art and informed by the teachings of the present disclosure.

Each of the six character regions within the fourth plurality of regions 388 is physically proximate a respective “soft” key (321-326). In operation, the function of a soft key is denoted by a message displayed within the six character region associated with that key. For example, in the case of six IM sessions being active at once, each of the six IM sessions may be with a respective user having a user name indicated within a respective six character field within the fourth active display region 388. Thus, a user of the wireless device 150 of FIG. 3 may shift context to a different session by activating the soft key associated with that session.

FIG. 4 (i.e., FIGS. 4A4C) depicts a graphical representation of a display sequence associated with an IM session. Specifically, FIG. 4 depicts exemplary visual output provided by the display device 380 of the wireless device 150 during a power-up sequence and subsequent IM session. Various steps within the sequence are numerically indicated and described in more detail along with the displayed information. It will be appreciated by those skilled in the art that the specific examples provided herein are only for illustrative purposes, that many and varied presentations of the displayed information and user inputs may be provided by those skilled in the art informed by the teachings of the present invention.

FIG. 4 specifically shows a plurality of display screens 380, where each display screen is modified in response to a user input. Each display screen 380 comprises a first active display region 382, a second active display region 384, a third active display region 386 and a plurality of fourth active display regions 388 (i.e., soft key indicative regions 388, through 388₆). More or fewer soft key indicative regions may be used. FIG. 4 also indicates that a soft key selection has been made by underlining the indicated soft key function in response to the selection of the associated key (e.g., keys 321-326).

Within FIG. 4, selection of a soft key is indicated by a heavy border around the selected soft key indicative region, while non-selected soft keys are indicated by a lighter border. The selected and non-selected soft keys may be indicated using flashing, underline, bold, colors and the like. The soft key messages may also be scrolled through the individual soft keys such that additional information may be provided. The soft keys may also indicate status information regarding their respective functions (i.e., session function, buddy list identification function and the like). In one embodiment, new messages are flashed on a display screen, as indicated by a dashed line surrounding the new message, and that audible alarms are optionally used.

At step 405, after a power-on condition, a welcome message is displayed in the first active pixel region 382, a “select a service” prompt is displayed in the third active pixel region 386, and soft key functions indicative of instant messaging service selections are displayed in the fourth active pixel region 388. Specifically, a first soft key indicator 388₁ is associated with the AOL Instant Messenger service, a second soft key indicator 388₂ is associated with the MSN Messenger service, and a third soft key indicator 388₃ is associated with the Yahoo! Messenger service. The remaining soft key indicators 388₄ through 388₆ are unused at this time (unless other services are available).

At step 410, the user has illustratively selected S1 (i.e., activated the soft key associated with the first soft key indicator region 388₁) to select the AOL Instant Messenger service and has entered a user name (e.g., “davebruce”). The controller causes the first display region 382 to indicate that the device is logging into the AOL Instant Messenger service, while the third region 386 prompts for the entry of a password.

At step 415, in response to entering the password pressing the “SEND” key, the controller causes the first display region to indicate that a log-on validation procedure is in effect and a prompt for the user to “Please wait” is provided in the third display region 386. Optionally, an animation or splash screen is displayed in one of the active pixel regions to indicate by its motion that the device is operating properly.

At step 420, in response to the entry of a correct password, the controller causes the first display region to indicate which users are presently on line (i.e., a “WHO'S ON” screen). Each buddy list having a member on line is indicated by a respective soft key indicator field 388. If no buddies in a particular group are on line, then the particular group will not appear in a soft key indicator field. The user may then select a desired buddy list by activating the soft key associated with that buddy list, and which particular buddy (or buddies) to open an IM session with by activating the increment 341 and decrement 342 keys to scroll between available on-line buddies of that selected buddy list. In response to an incorrect user name or password entry, the user is prompted again to enter correct user names and passwords.

At step 425, in response to the user pressing the “0” key (selecting thereby the “0” user within the “friend” buddy list) an IM session is opened with “aquariousbabe30.” The third display region 386 then indicates that the user is “Talking to aquariousbabe30” while the second display region 384 displays the user's typed message: “Hi there Becky.”

At step 430, in response to the user sending the user message (i.e., activating the “SEND” key 337 after typing the message), the sent message is displayed in the first display region 382 and, optionally, an audible alert is triggered.

At step 435, after receiving a response to the sent message, the response is displayed in the first display region 382 (“Aquariousbabe30:Hi Dad how are you doing?”).

At step 440, in response to receiving a message from another person on line (i.e., “gapgurl30”), the second soft key indicative region 388₂ illustratively flashes, scrolls, is underlined or otherwise is modified while (or prior to) displaying at least a portion of the user name associated with the new message. An audible alert is optionally played to alert the user.

At step 445, in response to the user selecting the second soft key (i.e., the key associated with the sender of the new message), the second soft key indicator region includes an underline (indicated by bold borders herein), the context of the IM session shifts to the new buddy, and the user may send a message to the new buddy.

At step 450, in response to the user typing “Hi Lauren” and pressing the send key, the user's message is displayed in the first display region 382. It is noted that the third display region 386 now indicates that the second buddy is the active IM session (i.e., “talking to gapgurl30”) and, optionally, an alert is sounded.

At step 455, in response to the user selecting the first soft key, the first soft key (the key associated with the original buddy) indicative field is highlighted and the third display region indicates that the user is now “chatting” (i.e., transferring text messages back and forth) with the first buddy (i.e., the initial IM session context is now active).

At step 460, in response to the user entering and sending a text message to the initial buddy (i.e., “Gotta Go-Bye!”), the first display region 382 displays the last view lines of the initial IM session, including the just-typed message. Additionally, the third display region 388 indicates that the user is “talking to Aquariousbabe30.”

At step 465, in response to receiving a message from Aquariousbabe30, the received message is displayed in the first display region 382 and an alarm is optionally sounded.

At step 470, in response to pressing the “BYE” key 335, the IM session with the first buddy Aquariousbabe30 is inactivated and only information associated with the second (active) IM session with gapgurl30 is displayed.

At step 475, in response to an incoming IM invitation from “strangeman” (strangeman is not on a buddy list of the user), the third display region 386 prompts the user to “Accept Chat with strangeman?” Also, the first and second soft key indicative regions are associated with, respectively, a “yes” response and a “no” response to the prompt.

At step 480, in response to the user selection of the first soft key (i.e., accept), the previous screen is displayed such that the active context is with the gapgurl30 IM session.

At step 485, in response to a new message received from gapgurl30, an alert is played and the new message is displayed within the first display region.

At step 490, in response to a new message received from “strangeman,” a new message alert is played and the second soft key indicative region flashes to indicate that the “strangeman” IM session may be selected.

At step 495, in response to the user selecting the second soft key to activate the “strangeman” IM session, the first display region 382 displays the received message from “strangeman.”

At step 498, in response to the user hitting the “BYE” key 335, the strangeman IM session is closed and the user returns to the IM session context with “gapgurl30.”

The above-described session of manipulations of FIG. 4 are facilitated by the “thumb typing” and other user input means previously described, the interactions with the various display regions of the display device 380, the optional audio alerts and the shifting of context between active IM sessions. It is noted that a plurality of IM sessions may be established and ongoing at any one time, and that the user has full control over which IM sessions are accepted and which are rejected. Each of the IM sessions is indicated, and selectable via, a respective soft key. In the case of a request for an IM session where no soft keys are available to indicate the new IM session (e.g., a seventh session in the exemplary embodiment), the entity requesting the IM session receives a “busy” or “call back later” message from the user. Optionally, the user is alerted to the IM session request so that one of the active sessions may be terminated to allow the new IM session to be established.

FIG. 5 depicts a graphical representation of a display sequence associated with a menu selection. Specifically, FIG. 5 depicts exemplary visual output provided by the display device 380 of the wireless device 150 during a MENU context. The display region identifications and conventions discussed above with respect to FIG. 4 are used in a consistent manner with respect to FIG. 5.

At step 505, in response to a user activating the “MENU” button while logged on, a “menu” screen is displayed within the first display region 382 of the display 380. In the exemplary embodiment, the displayed menu functions enable a user to log off of a service, add buddies to a IM session, change an away message (a message automatically provided in response to an invitation to participate in an IM session when the user is away or otherwise wishes to be undisturbed, register with a base station and perform other set-up functions such as volume control, display control, alert types and the like. Each of the available menu functions is associated with a respective soft key indicator region, such that activation of a key associated with the soft key region selects the function. In the event of a need to display more functions than the first display region will allow (or the number of soft keys will allow), the increment and decrement keys are used to access undisplayed functions. Moreover, as the increment and decrement keys are used to access such undisplayed functions, the specific soft key associated with the function is correspondingly adapted.

At step 510, in response to a user selecting the “log-off” function, a message is displayed within the first display region indicating that an instant messenger service log off procedure is activated. At step 515, after an appropriate delay, the menu screen is displayed again with one difference; namely, one of the menu functions available is now the log on function whereas the log off function was previously available.

It will be noted that the above-described use of soft keys has been primarily directed to contextually identifying the function of an actual key by having the function indicated by a display region proximate the key. However, the inventor also contemplates the use of soft keys to not only to allow the selection of new features, but also to simultaneously indicate a state of a session or other function associated with multiple soft.

For example, in the context of an open IM session where non-selected soft keys are associated with other IM sessions, the state of one or more of the non-selected session may be indicated by flashing, changing the color of, scrolling messages across or otherwise modifying the soft key information provided to the user. Such status changes may comprise keys receiving a new message or high priority message, a buddy dropping offline, the presence of an old or oldest message and the like. In this manner, the user is provided with multiple pieces of information (e.g., the soft key identifier and a corresponding state identifier) such that more intelligent and informed user decisions may be made. It is also noted that the user will learn something about the state of a non-selected session without actually switching the context to the non-selected session. The user also learns something about the state of that session without switching to it. An advanced display may utilize color changes to indicate, for example, various status information associated with the function corresponding to the soft keys (e.g., the IM session including the oldest message, including a new message, including a logout indicator and the like).

Therefore, in various embodiments of the invention, the proximate soft key identification display region is visually adapted in response to the selection of the corresponding key. The visual adaptation may comprise one or more of a flashing adaptation, an underline adaptation, a bold adaptation, a color adaptation, a moving text adaptation and the like. Those skilled in the are will readily devise other adaptations suitable for use in the present invention. In addition, the proximate soft key identification display region of non-selected (or non-active) keys may be used to provide contextual status information of the underlying non-selected function (e.g., status information regarding a non-selected buddy list in the “WHO'S ON” screen, status information regarding a non-selected menu function in the “MENU” screen, status information regarding a non-selected IM session where multiple IM sessions are active and the like.

It will also be appreciated by those skilled in the art that while the user input means have been primarily described as keys (including soft keys, dedicated keys and the like), other user input means may be provided such as pointing devices, rotary encoders, switches and the like. Moreover, the functions of these other user input means may be defined in the same manner as described above with respect to the soft keys (i.e., by displaying the function in a proximate display region). It is also noted that the display device may be adapted to conform to the shape of the alternate user input means, and that any of the user input means may protrude through he display device or overlap the display device.

Although various embodiments that incorporate the teachings of the present invention have been described herein, those skilled in the art can readily devise many other varied embodiments that still incorporate these teachings.

What is claimed is:

1. A user interface, comprising:
a plurality of display regions for identifying respective functions of corresponding input devices, said functions associated with an application having a plurality of contexts and changing as appropriate with changes in application context.

2. The user interface of claim 1, wherein:
said application comprises an instant messenger (IM) application including a chat screen context during which said identified functions comprise IM session selection functions.

3. The user interface of claim 2, wherein:
said instant messenger (IM) application includes a buddy selection screen context during which said identified functions comprise buddy list selection functions.

4. The user interface of claim 1, wherein:
said application includes a menu context during which said identified functions comprise menu selection functions.

5. The user interface of claim 2, wherein:
display regions associated with non-selected IM sessions further provide status information for said non-selected IM sessions.

6. The method of claim 5, wherein:
said status information comprises at least one of a new message indicator and a logoff indicator.

7. The user interface of claim 5, wherein:
the display region associated with a non-selected IM session having updated status information is visually adapted using at least on of a flashing, underlining and color adaptation.

8. The user interface of claim 2, wherein:
the display region associated with a selected IM session is visually adapted using at least on of a flashing, underlining and color adaptation.

9. The user interface of claim 1, further comprising:
an alarm, for selectively indicating contextually relevant events.

10. The user interface of claim 1, further comprising:
a main text display region for displaying chat messages, said main text display region and said plurality of display regions comprising distinct active pixel regions of a display device.

11. The user interface of claim 10, further comprising:
a send text display region, for displaying user entered text, said send text display comprising a distinct active pixel region of said display device.

12. The user interface of claim 11, further comprising:
a status text display region, for displaying status text, said status text display comprising a distinct active pixel region of said display device.

13. An instant messaging device, comprising:
a display, a keypad and a controller for controlling said display and keypad;
said display device having a first region for displaying instant messaging text, a second region for displaying user messages and a plurality of remaining regions for identifying contextual functions of respective proximate keys; wherein
in a first context, said respective proximate keys represent at least one buddy list identifying a respective group of users of said instant messenger service; and
in a second context, said respective proximate keys represent menu selections associated with application functions.

14. The device of claim 13, wherein:
in said first context, members of a presently selected buddy list are displayed in said first region.

15. The device of claim 13, wherein:
in said first context, members of a presently selected buddy list are displayed in said first region.

16. The device of claim 13, further comprising:
an alarm, for selectively indicating contextually relevant events.

17. The device of claim 13, wherein:
the display region proximate a key is visually adapted in response to the activation of the key.

18. The device of claim 17, wherein the visual adaptation of the display region comprises one of a flashing, an underlining and a color adaptation.

19. The device of claim 13 wherein each of said display regions associated with a contextually active event provides status information associated with that event.

20. Apparatus, comprising:
a display device including a plurality of active display region separated by at least one inactive display region, said active display regions including respective groups of controllable picture elements;
a keypad including a predefined number of keys disposed proximate corresponding active display regions, each of said plurality of keys implementing a function indicated by its corresponding active display region, said functions changing in response to changes in context of a user interface.

21. A user interface adapted for use in an instant messenger application, comprising:
a display device having a first region for displaying IM text, a second region for displaying user messages and a plurality of remaining regions for identifying contextual functions of respective proximate keys.

22. An instant messaging communications device, comprising:
a keypad including a plurality of keys disposed proximate a first region of a display device; and
a controller, for controlling said display device and keypad to implement a user interface supporting at least one instant messenger service session; wherein
in a first context, each of said at least one instant messenger service sessions being associated with a respective one of said plurality of keys disposed proximate said first display region; and
in a second context, each of at least one buddy list being associated with a respective one of said plurality of keys disposed proximate said first display region.

23. The device of claim 22, wherein:
in a third context, each of at least on menu selections associated with application functions being associated with a respective one of said plurality of keys disposed proximate said first display region.
